(19) United States
(12) Patent Application Publication
(10) Pub. No.: US 2026/0122026 A1
(43) Pub. Date: Apr. 30, 2026

(54) Generating Sequential Flows of Electronic Actions

(71) Applicant: Klaviyo, Inc., Boston, MA (US)

(72) Inventors: Annika Sougstad, Boston, MA (US); Thomas Nolan, Boston, MA (US); Christopher Robert Carrick, Davie, FL (US); Robert John Long, Dublin (IE)

(73) Assignee: Klaviyo, Inc., Boston, MA (US)

(21) Appl. No.: 18/927,888

(22) Filed: Oct. 26, 2024

(51) Int. Cl. H04L 51/42; H04L 51/21

(52) U.S. Cl. CPC H04L 51/42; H04L 51/21

(57) ABSTRACT

Apparatuses, methods, and systems for generating a sequential flow of electronic actions for a user are disclosed. One method includes sensing a flow trigger action, scraping characteristics of an electronic presence of the user, characterizing user identifying information using an LLM (large language model) and the characteristics, determining a selection of actions and conditional splits (branches) to form a sequential flow of electronic messages for sub-users of the user, generating one or more electronic messages based on the identifying information and the determined sequential flow of electronic messages, displaying the one or more electronic messages to the user, sensing actions of the user based on the displaying of the one or more electronic messages, finalizing the electronic messages based on the sensed actions of the user, and electronically sending the one or more finalized electronic messages to sub-users of the user.

### FIELD OF THE DESCRIBED EMBODIMENTS

The embodiments described relate generally to managing intelligent electronic interactions. More particularly, the described embodiments relate to systems, methods, and apparatuses for generating sequential flows of electronic actions.

### BACKGROUND

Users frequently send electronic messages to current and prospective sub-users to solicit a response from sub-user recipients. Further, users may want to generate sequences of electronic messages for sub-users to solicit action by the sub-users.

It is desirable to have methods, apparatuses, and systems for generating sequential flows of electronic messages.

### SUMMARY

An embodiment includes a computer-implemented method for generating a sequential flow of electronic actions for a user. The method includes sensing, by a server, a flow trigger action, scraping, by the server, characteristics of an electronic presence of the user, characterizing, by server, user identifying (branding) information using an LLM (large language model) and the characteristics, determining, by the server, a selection of actions and conditional splits (branches) to form a sequential flow of electronic messages for sub-users of the user, generating, by the server, one or more electronic messages based on the identifying (branding) information, and the determined sequential flow of electronic messages, displaying, by the server, the one or more electronic messages to the user, sensing actions of the user based on the displaying of the one or more electronic messages, finalizing the electronic messages based on the sensed actions of the user, and electronically sending the one or more finalized electronic messages to sub-users of the user.

Another embodiment includes an apparatus for electronic categorization of sub-users of a database for receiving an electronic action. The apparatus includes a flow server, a user server connected through a network to the flow server, and a plurality of sub-user computing devices connected through the network to the user server and the flow server. The flow server is configured to sense a flow trigger action, scrape characteristics of an electronic presence of the user, characterize user identifying information using an LLM (large language model) and the characteristics, determine a selection of actions and conditional splits (branches) to form a sequential flow of electronic messages for sub-users of the user, generate one or more electronic messages based on the identifying (branding) information, and the determined sequential flow of electronic messages, display the one or more electronic messages to the user, sense actions of the user based on the displaying of the one or more electronic messages, finalize the electronic messages based on the sensed actions of the user, and electronically send the one or more finalized electronic messages to sub-users of the user.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a system for generating sequential flows of electronic messages, according to an embodiment.

FIG. 2 shows an example of a sequential flow, according to another embodiment.

FIG. 3 shows a system for generating sequential flows of electronic messages, according to another embodiment.

FIG. 4 shows a system for generating sequential flows of electronic messages, according to another embodiment.

FIG. 5 shows a system for generating sequential flows of electronic messages, according to another embodiment.

FIG. 6 shows a system for generating sequential flows of electronic messages, according to another embodiment.

FIG. 7 is a flow chart that includes steps of a method for generating sequential flows of electronic messages, according to an embodiment.

FIG. 8 shows electronic messages of a sequential flow of electronic messages, wherein each electronic message includes different content or behavior, according to an embodiment.

### DETAILED DESCRIPTION

The embodiments described include methods, apparatuses, and systems for generating sequential flows of electronic actions. Improvements in the generation of sequential flows of electronic actions (messages) and the corresponding electronic messages saves a user time in creating the electronic messages. Additionally, improved messages result in better performance (which can be measured by actions of a user and/or by sensed actions of recipients of the generated electronic messages) of the electronic messages. For at least some other embodiments, the electronic messages are generated to be sent in response to some action, such as, an abandoned shopping cart notification, a new subscriber welcome, and/or a one-time message send. At least some embodiments include tuning or adjusting parameters of the sequential flows of electronic actions including at least one of adjusting the generation of the sequential flow of electronic actions, the generation of the text of the electronic messages, adjusting send times of the electronic messages, adjusting a list of recipients that receive the electronic messages, and/or adjusting a display (such as motion of the display or a positioning of objects on the display). For an embodiment, the parameters of the sequential flows of electronic actions are adjusted based on sensing an action of recipients (sub-users) of the electronic messages. For an embodiment, the parameters of the sequential flows of electronic actions are adjusted based on sensing an action of a user of the electronic messages. It is to be understood that one form of the electronic actions includes electronic messages. However, for at least some embodiments, the electronic actions additionally or alternatively include other electronic actions, such as, an action to update or modify a website appearance for identified sub-users. The update or modification of the website can be controlled at least in part on the sensed action of the sub-users. For at least some embodiments, the electronic actions additionally or alternatively include other electronic actions, such as, an action to reduce the size (amount of data) of a generated electronic message based on the connectivity link to a computing device of the sub-users. For example, if a sub-user is detected to be using a mobile phone, or a mobile phone connected via satellite, the connection to the computing device of the sub-user can be improved by reducing the amount of data included within the generated electronic message to improve the connection to the computing device of the sub-user. Further, the electronic action may include an action to limit website access by certain sub-users to improve security of the website.

The embodiments described solve practical problems associated with automatic generation of sequential flows of electronic messages and corresponding electronic messages that are likely to solicit a response from recipients (sub-users) of sequential flows of electronic messages. The electronic actions can include information to be conveyed to sub-users (recipients). The information can be related to anything, such as safety alerts (for example, a need for vaccinations, of natural disasters, or criminal activity), wildfires, political events, etc.

Further, the described embodiments further solve practical problems associated with tuning the generation of sequential flows of electronic messages and the corresponding electronic messages based on preferences and actions of users and based on tracking and monitoring the actions of recipients (sub-users) of the electronic messages. Additionally, the different electronic messages may include different content and/or behavior. For an embodiment, the behavior can include the behavior of the display of the different electronic messages being different. For example, the display of different electronic messages may include motion of the display of the electronic messages or placement of objects or information on the display based on sensed actions of the recipients of the electronic messages. Accordingly, based on the sensed behavior of recipients (sub-users) of the electronic messages, the display may selectively adjusted to improve the user interface computing devices of the recipient sub-users. Further, the embodiments described can be used to improve connections to computing devices of sub-users by throttling back the amount of data in electronic message generated for users when a conditional point of the sequential flow identifies that the computing device of the sub-user has a low quality link connection and the connection to a network would be improved by generating electronic messages that have less data.

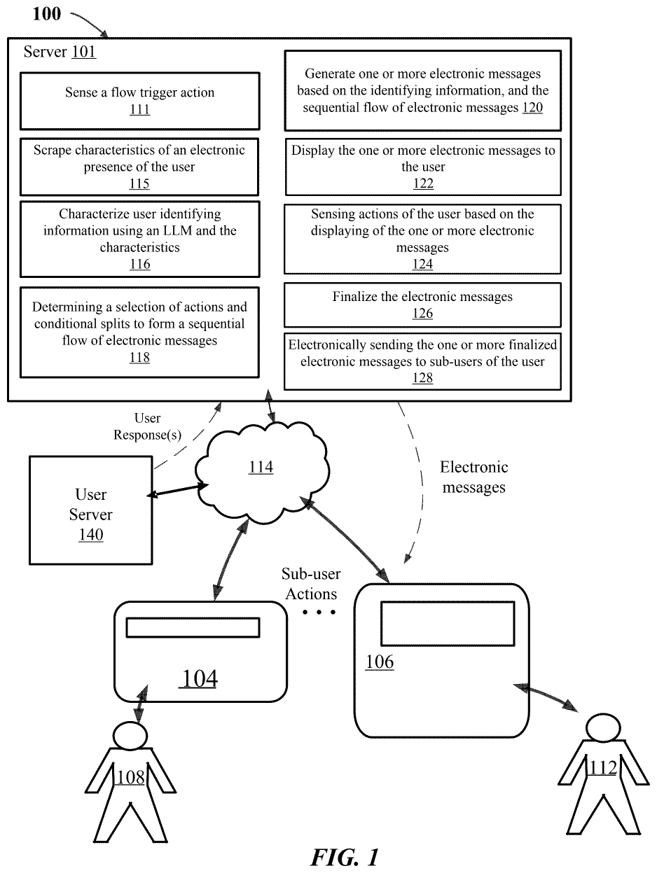

FIG. 1 shows a system 100 for generating sequential flows of electronic messages, according to an embodiment. The system 100 includes a server 101 that is connected through an electronic network 114 to at least a user server 140 of a user. For an embodiment, the user server 140 manages a website of the user. It is to be understood that the term “user” is being used liberally. For example, a user can include, for example, a governmental agency, a teacher, a doctor, a restaurant owner, etc. Further, it is to be understood that at least some embodiments for generating sequential flows of electronic messages are implemented at the server 101 which is accessed by the user on a client side of the server 101. Specifically, for an embodiment, generating sequential flows of electronic messages is performed by a UI (user interface) of the server 101. For an embodiment, the user provides control to the server 101 through the user server 140. For an embodiment, the sub-users have visited the website of the user.

For an embodiment, the server 101 is configured to sense 111 a flow trigger action. The sensed flow trigger action operates to trigger the generation of one or more sequential flows of electronic actions or messages. For an embodiment, sensing the flow trigger action comprises sensing an activity of the user indicating a need for generating the sequential flow of electronic messages for the user. For an embodiment, sensing the flow trigger action includes at least one of the user initiating a welcome series setup, the user accessing the server and navigating to welcome series workflow builder, a new user signing up, a website of the user changing, or identifying a prospective user and user website. For an embodiment, a condition associated with the user is identified, and the identification triggers the generation of one or more sequential flows of electronic messages for sub-users of the user. The conditions can be identified by monitoring, for example, the location of a computing device of a sub-user, or a proximity of the computing device to an area or location. For example, identifying a health alert (such as, a deadly virus) or an imminent natural disaster (such as, a hurricane) may trigger a sequential flow of electronic messages for a governmental agency to aid the government agency in soliciting a response by sub-users to take some sort of action. Further, sensing action or non-action by the sub-users can be used for determining conditions of the sequential flows of electronic messages for sub-users. Further, a condition can be identified by sensing a type of computing device or a type or quality of connection (such as, cellular or satellite connection) of the computing device to a network. The computing device or a type or quality of connection can dictate an action of controlling an amount of data used in the generation of electronic messages to enhance computing a network performance by being adapting the data rate demand (or allocation) used by the electronic message when delivered to the computing devices of the sub-users.

For an embodiment, the server 101 is configured to scrape 115 characteristics of an electronic presence of the user. For an embodiment, scraping characteristics of the electronic presence of the user includes one or more of scraping an input or current message of the user, scraping characteristics of a user website, scraping characteristics of other electronic messages of the user, scraping code of the current message of the user. For an embodiment, the input message is a message input by the user to the server 101. Scraping characteristics of the user website or any other electronic presence of the user provides determinations of a tone, seriousness, urgency, branding, etc. of the user website. These characteristics can then be included within the electronic messages generated for the user. For at least some embodiments, scraping characteristics of the electronic presence of the user includes one or more of a website of the user (determined to be similar with the current user), social media, or other online retail stores (TikTok® shop, Amazon®). For an embodiment, scraping characteristics of other electronic messages of the user includes scraping code of the current (input) message of the user, scraping code of other messages of the users, and scraping code of one or more websites of the user.

At least some embodiments include scraping user data from previous electronic messages of the user. It is to be understood that the user information can additionally include information of sub-users of the user, wherein the sub-users have had a prior electronic interaction or engagement with the user, such as, visiting a website of the user. For an embodiment, the created and suggested electronic messages and/or sequences of electronic messages are based on the user information including engagement information of sub-users of the user related to previous communications or website interactions of the sub-users with the user. Further, for at least some embodiments, additional information of sub-users of the user includes information previously captured through, for example, survey response, demographic information, or geographic information. Further, the scraping may be used to determine the color preferences of the user if generating electronic communication for the user. For an embodiment, determination is based on scraping code of a current message of the user. For an embodiment, the determination is based on scraping code of other messages of the user. For an embodiment, the determination is based on scraping code of one or more websites of the user. For an embodiment, the color determination is directed to text or wording of the user. An embodiment includes making the determination by counting letters of electronic messages or websites allocated to each color. An embodiment includes making the determination by counting words of the messages or websites allocated to each color. An embodiment includes determining the top X (such as, two) common background colors. For an embodiment, this includes scraping the code of the messages or websites of the user to determine the percentage of the background that is allocated to each color. An embodiment includes determining the top selectable button colors. For an embodiment, this includes scraping the code of the messages or websites of the user to determine the percentage of the selectable buttons that are allocated to each color.

For an embodiment, the server 101 is configured to characterize 116 user identifying information using an LLM (large language model) and the characteristics. For an embodiment, the user identifying information includes branding information. For an embodiment, characterizing the user identifying information includes entering the characteristics into the LLM and receiving back the characterized user identifying information. As will be described, the output (user identifying information) can be tuned (adjust future characterizations) by determining how well the characterized user information is in soliciting responses by sub-users who receive electronic messages generated based on the characterized user identifying information. The determination of how well the characterized user identifying information is can be determined based on sensing user actions and/or sub-user actions. Further, identifying information can be comparatively tested with varying content, send times, and/or sub-user devices. For an embodiment, characterizing the user identifying information using the LLM and the characteristics include entering the characteristics including a spoken language of a website, colors of the website, images of the website, button selections of the website, and receiving the characterized user identifying information back from the LLM.

For an embodiment, the inputs to the LLM include the user identifying information as determined through scraping of the electronic presence of the user, and prompt/instructions, resulting in the characterized user identifying information in a structured data format. For an embodiment, the prompt/instructions include, for example, identifying the writing style of the user. For an embodiment, the structured data format includes, for example, {‘writing_style’: ‘heavy use of emojis, cheerful tone’.

For an embodiment, the characterized user identifying information includes current information of the user including, for example, a company name, product names/descriptions, 3-5 words for brand tone, and/or descriptions of writing style. For an embodiment, the characterized user identifying information includes things to aid the server in generating messages similar to what the user would have written.

For an embodiment, the server 101 is configured to determine 118 a selection of actions and conditional splits (branches) to form a sequential flow of electronic messages for sub-users of the user. For an embodiment, determining the selection of actions and conditional splits (branches) to form the sequential flow of electronic messages for sub-users of the user includes receiving one or more selections of a plurality of pre-generated sequential flows of electronic messages from the user. That is, for an embodiment, a plurality of sequential flows of electronic messages are pre-generated, and the pre-generated sequential flows are presented to the user for selection.

For an embodiment, determining the selection of actions and conditional splits (branches) to form the sequential flow of electronic messages for sub-users of the user includes determining one or more selections of a plurality of sequential flows of electronic messages of similar users to the user. That is, the plurality of sequential flows that were utilized by similar users are identified. These plurality of sequential flows of electronic messages are then presented to the user for selection. For at least some embodiments, users can be identified as similar by industry, product areas, and/or geography (location of the user).

For an embodiment, determining the selection of actions and conditional splits (branches) to form the sequential flow of electronic messages for sub-users of the user include receiving one or more selections of a plurality of sequential flows of electronic messages adaptively generated from the user. That is, for an embodiment, the plurality of sequential flows of electronic messages are electronically generated by, for example, an LLM or some other sequential flow generative engine. For at least some embodiments, the inputs to the sequential flow generative engine include, for example, industry, geography, time zone, sub-user location, sub-user demographics, similar user sequential flows, and/or previously or currently determined high performing sequential flows.

For an embodiment, sensed user action in response to being displayed determined sequential flows is used to tune or adjust future determinations of sequential flows of electronic messages. For an embodiment, selections of sequential flows are received from the user. For an embodiment, actions including selections, amendments of, or rejections of sequential flows, and a timing of each of the selections, amendments of, or rejections of sequential flows are used to tune or adjust future determinations of sequential flows including tuning or adjusting conditions (conditional splits) and electronic actions of the sequential flows. As described, for at least some embodiments, the conditional spits include, for example, sub-user action or inaction, timing of sub-user actions, detection of sub-user device type (stationary computing device, mobile computing device, satellite connection computing device), detection of sub-user location, previous sub-user actions (sub-user has performed an action, such as, purchased before or purchased amount), sub user site visits or actions on website. For at least some embodiments, electronic actions of the sequential flow(s) include sending an electronic message, sending a type of electronic message (content, timing, character (email, SMS, others?). Further, as described, the electronic actions can extend to improve performance of the network by updating the user website which may improve operation of the website including security, or throttling data communicated to the sub-users based on the computing device of the sub-user to improve network performance, and/or updating application available to the sub-users.

For an embodiment, the server 101 is configured to generate 120 one or more electronic messages based on the identifying (branding) information, and the determined sequential flow of electronic messages. For an embodiment, a text generating engine generates the electronic messages based on inputs of the identifying information, and information of the sequential flow of electronic messages. For an embodiment, the text generating engine includes an LLM. For at least some embodiment, additional information is input to the text generation engine, such as, an input description from the user.

For an embodiment, the server 101 is configured to display 122 the one or more electronic messages to the user. Once displayed, for an embodiment, the server 101 is configured to sense actions 124 of the user based on the displaying of the one or more electronic messages. For an embodiment, the sensed actions include receiving an acceptance, or approval of the one or more electronic messages from the user. For an embodiment, the sensed actions include receiving a non-acceptance from the user. For an embodiment, the sensed actions include receiving editing of the one or more messages by the user. Other sensed user actions may include timing how long the user reviews the display or sensing the user closing a page.

For an embodiment, the sensed actions of the user can then be used to update stored user identifying information, influence future sequential electronic message generation, and influence electronic messages generated in the future, and influence the set of actions and conditional splits in the sequential flow for the future. For an embodiment, the LLM is trained based on the feedback from the sensed user actions for future characterized user identifying information. For an embodiment, future generation sequential flow of electronic messages for sub-users of the user are updated based on the feedback from the sensed user actions. For an embodiment, future generation of the one or more electronic messages based on the identifying (branding) information, and the determined sequential flow of electronic messages are updated based on the feedback from the sensed user actions.

For an embodiment, the server 101 is configured to finalize 126 the electronic messages based on the sensed actions of the user. For an embodiment, the finalizing includes accepting or updating the electronic messages based on the sensed user actions.

For an embodiment, the server 101 further operates to perform an electronic action (such as, sending electronic messages 128) directed to the sub-users identified to receive the one or more electronic messages. For an embodiment, the server 101 further operates to send electronic messages to computing devices 104, 106 of identified sub-users 108, 112. For an embodiment, the sub-users 108, 112 are identified as having visited a website of the user. For an embodiment, the electronic action includes reporting various metrics for specific groups of sub-users (also referred to as a “segment” of sub-users) of the user (e.g. various conversion rates, revenue, demographic data, etc.). For an embodiment, the electronic action includes suggesting a variety of custom-tailored messages and content for the segment of sub-users to the user. For an embodiment, the server 101 monitors sub-user actions in response to the electronic action. The monitored sub-user actions can be used to learn preferences and model engagement patterns for the sub-user recipients of the segment (for example, preferred send time for various types of electronic messages).

For an embodiment, the server 101 is configured to electronically send the one or more finalized electronic messages to sub-users of the user. For at least some embodiments, feedback from users and feedback from the sub-users upon receiving the finalized electronic messages is used to influence the generation of future electronic messages, influence generation of future sequential flows of electronic messages, and influence the future characterization of the user identifying information. Further, for an embodiment, the conditions of the determined sequential flows of electronic messages are determined by the sensed actions (or lack thereof) of the users, sub-user, or timing of the sensed actions of the users and/or sub-users.

As previously described, at least some embodiments further include sensing action of the sub-users in response to receiving one or more electronic messages. At least some embodiments further include monitoring and tracking, by the server, responses of the sub-users to receiving the electronic messages, determining, by the server, a level of success of each of different of the electronic messages, and updating the generating of the electronic messages based on the determined level of success of each of different of the electronic messages. At least some embodiments further include feeding back the level of success of each of the different electronic messages to a generator that generated the different electronic messages.

As previously described, at least some embodiments further include sensing action of the sub-users in response to receiving the sequential flow of electronic messages and feeding back the level of success of each of the sequential flow of electronic messages to a generator that generated the sequential flow of electronic messages. At least some embodiments further include monitoring and tracking, by the server, responses of the sub-users to receiving the sequential flow of electronic messages, determining, by the server, a level of success of each of different of sequential flows of electronic messages, and updating the generating of the sequential flows of electronic messages based on the determined level of success of each of different of the sequential flows of electronic messages. For an embodiment, updating the generating of the sequential flow of electronic messages includes feeding back the level of success of each of different sequential flows of electronic messages to a generator that generated the sequential flows of electronic messages.

An embodiment includes suggesting, by the server, two or more versions of the sequential flows of electronic messages, electronically sending the two or more versions of the sequential flows of electronic messages to sub-users, monitoring actions of the sub-users in response to receiving the two or more versions of the sequential flows of electronic messages, and ranking the two or more versions of the sequential flows of electronic messages based on the monitored actions of the user and/or sub-users. At least some embodiments further include training a generator that generated the sequential flows of electronic messages based on the ranking of the two or more versions of the sequential flows of electronic messages.

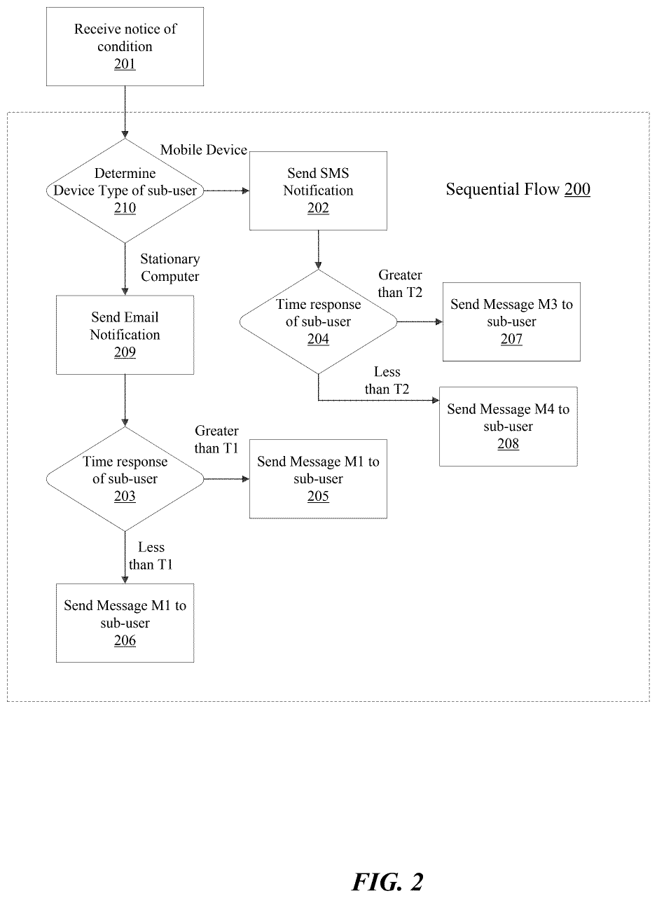

FIG. 2 shows an example of a sequential flow of electronic actions 200, according to another embodiment. For an embodiment, the sequential flow 200 is initiated based on determining (sensing) or receiving a condition that triggers the sequential flow 200. For example, a sensed action by the user or a sub-user may trigger the sequential flow. For an embodiment, the sequential flow 200 is triggered by sensing or receiving a notice of a condition 201. The condition can include, for example, sensing an activity of the user indicating a need for generating the sequential flow of electronic messages for the user. For an embodiment, sensing the flow trigger action includes at least one of the user initiating a welcome series setup, the user accessing the server and navigating to welcome series workflow builder, a new user signing up, a website of the user changing, or identifying a prospective user and user website. For an embodiment, a condition associated with the user is identified, and the identification triggers the generation of one or more sequential flows of electronic messages for sub-users of the user. For example, identifying a health alert (such as, a deadly virus) or an imminent natural disaster (such as, a hurricane) may trigger a sequential flow of electronic messages for a governmental agency to aid the government agency in soliciting a response by sub-users to take some sort of action. Further, sensing action or non-action by the sub-users can be used for determining conditions of the sequential flows of electronic messages for sub-users.

The exemplary sequential flow of electronic actions 200 of FIG. 2 includes receiving or determining condition 210 of a device (the condition being a stationary computing device or a mobile computing device) of the sub-user. If the device (computing device) of the sub-user is a stationary computer, an action 209 includes sending an email to the sub-user. If the device (computing device) of the sub-user is a mobile computing device, action 202 includes sending an SMS (Short Message Service) to the sub-user. After the action 209 of sending the email to the sub-users, a sensed condition 203 includes timing a response of the sub-user. If the response is greater than a time T1, then action 205 includes sending a message M1 to the sub-user, and if the response is less than time T1, the action 206 includes sending a message M2 to the sub-user.

After the action 202 of sending the SMS notification to the sub-users, a sensed condition 204 includes timing a response of the sub-user. If the response is greater than a time T2, then action 207 includes sending a message M3 to the sub-user, and if the response is less than time T2, the action 208 includes sending a message M4 to the sub-user. It is to be understood that the sequential flow 200 of FIG. 2 is merely an example. As described, the action and conditions can vary in different ways to improve the performance of the system and the network between devices of the system.

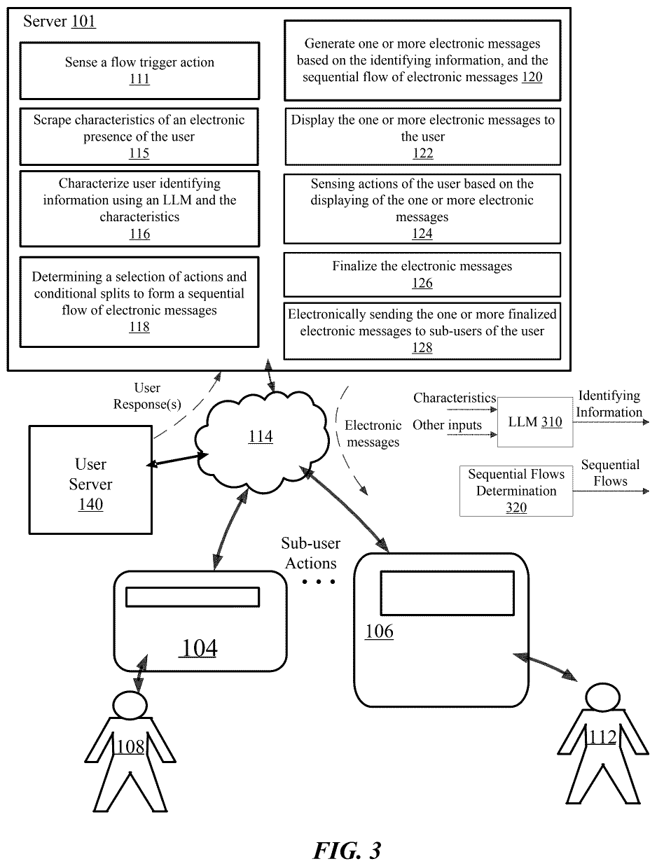

FIG. 3 shows a system for generating sequential flows of electronic messages, according to another embodiment. FIG. 3 additionally shows an LLM 310 configured to characterize the user identifying information based on, for example, the scraped characteristics of the user. Further, the LLM 310 may receive other input, such as, user location and/or device type for characterizing the user identifying information.

Further, FIG. 3 includes a sequential flow determination engine 320. As previously described, for an embodiment, the sequential flow determination engine 320 is configured to generate sequential flows of electronic messages based on one or more selections of a plurality of pre-generated sequential flows of electronic messages from the user, one or more selections of a plurality of sequential flows of electronic messages of similar users from the user, and/or one or more selections of a plurality of sequential flows of electronic messages adaptively generated from the user.

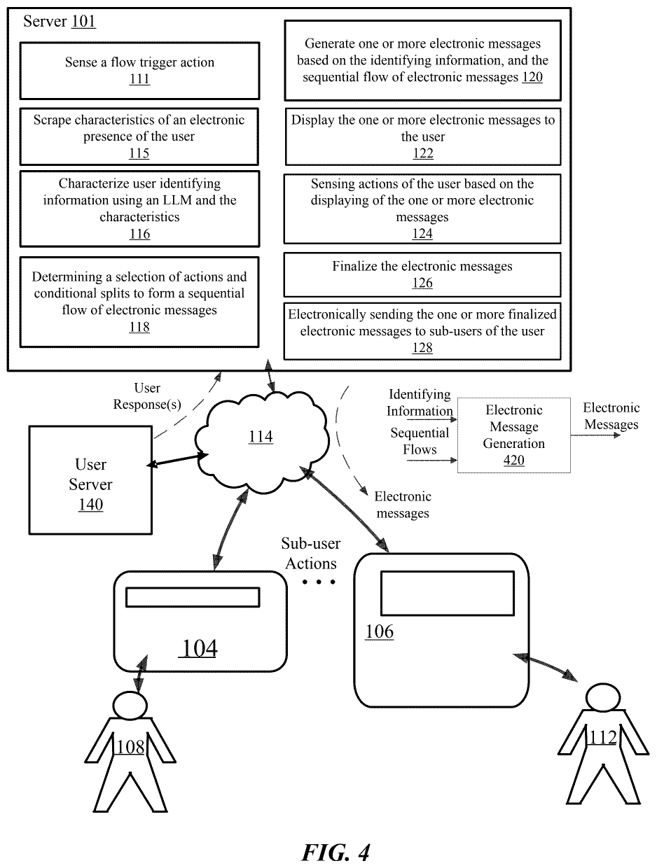

FIG. 4 shows a system for generating sequential flows of electronic messages, according to another embodiment. As shown, this embodiment includes an electronic message generation engine 420 that generates electronic messages for sub-users of the user based on at least the user identifying information, and the determined sequential flow of electronic messages.

A text generation model of the electronic message generation engine 420 may include an LLM (large language model) that receives the identifying (branding) information, and the determined sequential flow of electronic messages. As described, for an embodiment the generator includes an LLM (large language model) that receives a textual input of the identifying information, and the determined sequential flow of electronic messages. For an embodiment, the electronic generation model additionally receives an input description from the user. For an embodiment, the identifying information, and the determined sequential flow of electronic messages are not limited to text. The identifying information, the determined sequential flow of electronic messages, and/or the input descriptions may include images as well. For an embodiment, the identifying (branding) information, and the determined sequential flow of electronic messages include one or more images, and the electronic generation model 420 includes a MMLLM (multi-modal large language model). For an embodiment, the user feedback and sensed sub-user actions are used for training the MMLLM.

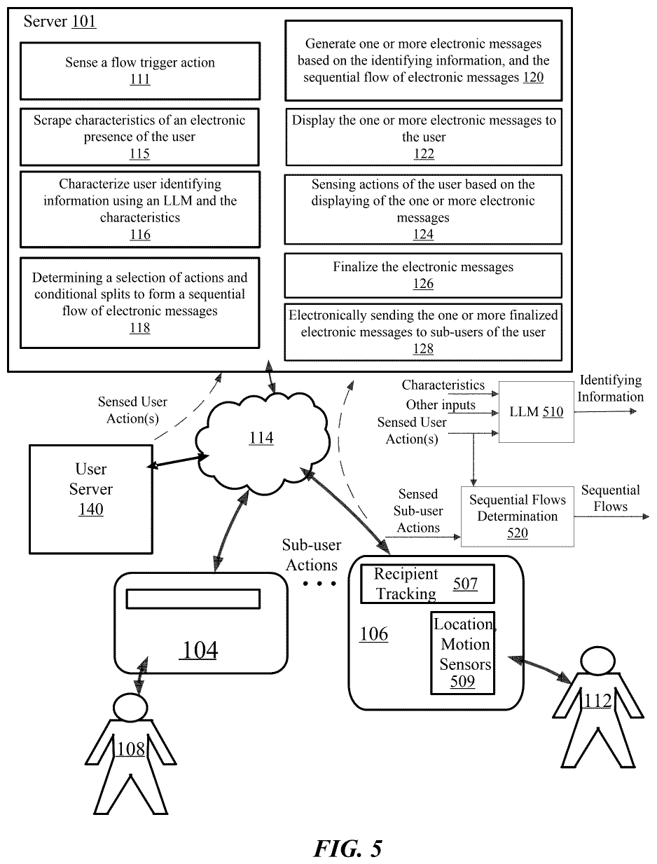

FIG. 5 shows a system for generating sequential flows of electronic messages, according to another embodiment. As shown, this embodiment further includes an LLM 510 receiving at least the scraped characteristics of the user, the other input, such as, and/or the sensed user actions. As described, for at least some embodiment the sensed user actions are used to train the LLM 510 to influence the characterization of future user identifying information.

Further, this embodiment includes the sequential flows determination engine 520 configured to generate sequential flows of electronic messages based on sensed actions of the sub-users. For example, for an embodiment, the sensed user and/or sensed sub-user actions may be used to gauge a level of success of each of a plurality of generated sequential flows of electronic messages. For an embodiment, the levels of success of each of the plurality of generated sequential flows of electronic messages is fed back to the LLM 510 for improvement and adjustment of future generated sequential flows of electronic messages. The improvements in the generation of the generated sequential flows of electronic messages improves the user interface of the displays viewed by the sub-users that receive the electronic messages of the plurality of generated sequential flows of electronic messages.

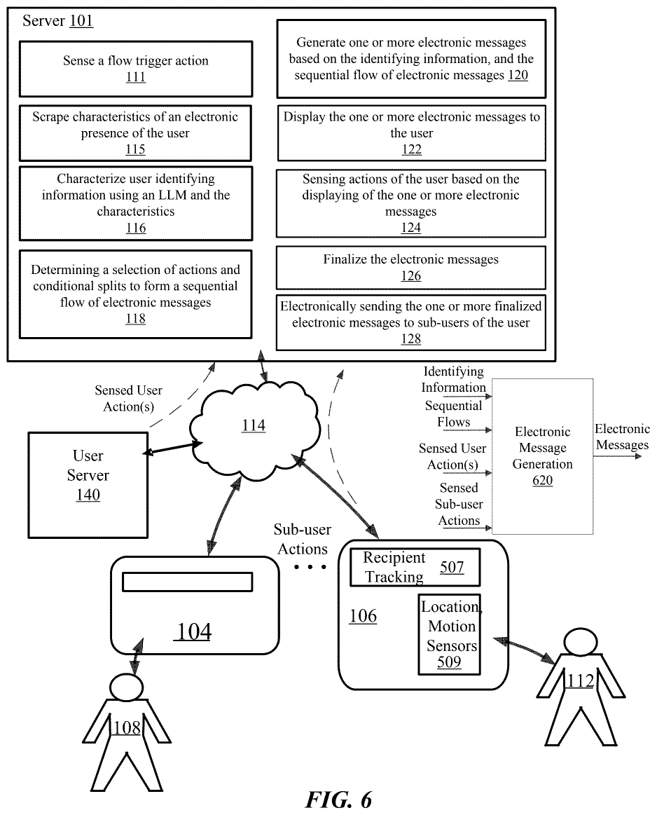

FIG. 6 shows a system for generating sequential flows of electronic messages, according to another embodiment. This embodiment further includes the electronic message generation engine 620 generating the one or more electronic messages based on one or more of the user identifying information, the determined sequential flow of electronic messages, sensed user actions, and/or sensed sub-user actions.

### Tracking Sub-User (Electronic Message Recipient) Actions

As previously described, for an embodiment, the server 101 further operates to electronically send the set of generated electronic messages to computing devices 104, 106 of sub-users 108, 112. For an embodiment, the computing devices 104, 106 of the sub-users 108, 112 are electronically connected to the server 101 and the user server 140 through, for example, the network 114. For an embodiment, the server 101 tracks sub-user actions based on the electronic messages displayed to one or more sub-users 108, 112 of the user of the user server 140.

For an embodiment, when the sub-user loads a webpage of the user, user-tracking code is loaded in through a JavaScript bundle and utilized within the browser of the sub-user. For an embodiment, actions of the sub-user on the website of the user can be tracked. Further, a mobile device of a sub-user can be tracked to determine other possible actions of the sub-user. For an embodiment, forms that have been filled out and submitted to the website of the user can be monitored and tracked. For an embodiment, behavior of the sub-user's internet browser or device (that would affect communication of a message or a sub-user's desired action) can be monitored or tracked. For an embodiment, navigation by the sub-user to a website or URL (universal resource locator) can be sensed, tracked, and monitored.

For an embodiment, the user-tracking code can utilize sensors on the computing device of the sub-user to track actions of the computing device. For example, the computing device may be a mobile device that includes motion and location sensors that can identify actions of the sub-user that can be correlated with the sub-user having received a displayed form. Further, actions of multiple sub-users can be sensed to determine correlations between different sub-users.

For an embodiment, the tracking of the sub-users includes tracking online activity and action by the sub-users. For an embodiment, a sub-user device (such as, devices 104, 106) alone or in conjunction with the server 101, or the user server 140 operates to sense the sub-user action data. For an embodiment, the sensed and tracked sub-user action data includes the sub-user computing device electronically sensing a sub-user performing an action or activity in response to the displaying of the electronic messages to the sub-user. For an embodiment, sensing the sub-user performing an action includes sensing that the sub-user is selecting or “clicking” a link included within the generated electronic message(s).

While the described embodiments are directed towards sensing sub-user action data, it is to be understood that at least some other embodiments can additionally or alternatively include the sensing of other types of data as well. For an embodiment, the sensed data can include user server data, such as, web traffic and purchases among message recipients. That is, the sensed sub-user action data could be replaced with, for example, data of daily total or new visitors on the user website.

The sub-user action data may be tracked (counted) over various possible time periods (such as, by the second, minute, hour, day, week, or month) and may include one or more of sub-users (108, 112) being active on the website of the user server 140, a sent email bouncing, a sub-user canceled order, a sub-user starting a checkout, a sub-user clicking (selecting) an email, a sub-user opening email, a sub-user placing order, a sub-user receiving email, a sub-user refunding an order, a sub-user unsubscribing, a sub-user viewing a product, a sub-user adding to a list (a list in the marketing automation platform of the server 101 account), and/or a sub-user adding an item to their cart.

It is to be understood, however, that there are very few limitations on what event types (sub-user actions) can be published (provided) to an automation platform of the server 101. Website managers (such as website manager of the user server 140) can implement their own events (sensed sub-user actions) that make sense for their business and simply send those events over to the automation platform of the server 101.

Further, as will be described, implementations of computing devices 104, 106 that include mobile devices that include recipient tracking sensors 507 and location/motion sensors 509 and can additionally or alternatively include additional types of sensed sub-user actions. Such sensed sub-user action can include sensing a physical sub-user visit and/or purchase. Further, such sensed sub-user action can include sensing a virtual sub-user visit and/or purchase online. That is, the sensing of the sub-user action can include sensing the sub-user visiting a physical location of the user, and/or the sub-user purchasing a product or service of the user at a physical store location of the user. Further, the sensed sub-user actions can include combinations or sequences of sub-user actions. For an embodiment, sensed sub-user actions are weighted based on the sensed sub-user actions. For an embodiment, only sensed sub-user actions having a weight, or a combination of weights that exceed a sub-user action threshold are considered a sub-user action for the purposes of detecting sub-user actions.

For an embodiment, the location monitoring of the mobile device of the sub-user is used to identify business locations visited by the recipient after receiving the electronic message(s) of the marketing message. Different businesses can be rated, wherein particular businesses yield a higher sub-user action score, and other particular businesses yield a lower engagement score. The sub-user action score of each business can be adaptively adjusted based on the electronic marketing message of the user and can be adjusted based on other businesses visited by the recipient. For an embodiment, patterns of location visits by the recipient can be used to influence the level of sub-user action.

For an embodiment, motion of the recipient is tracked by location and motion sensors 509 and can be used to influence the level of sub-user action. Certain actions (motions) of the recipient may indicate different levels of sub-user action. For an embodiment, the computing devices 104, 106 may include a mobile phone, a smart watch, or a headset. Motion of the recipient can include tracking hand motions, direction of eyesight, and/or orientations of the recipient. Accordingly, whether the recipient is in a physical location of a product of the user can be determined. Further, how long the recipient holds or looks at a specific product of the user can be determined. Further, whether the recipient interacts with another recipient can be determined. All the sensed/tracked locations and motions of the sub-user can be included within a score of the sub-user action. For example, visiting a restaurant after receiving a message is a very possible use case since this is an in-person sub-user action. Again, a score that exceeds a score threshold can be deemed a sub-user action. The actions and locations of the sub-user can be tracked 307 allowing patterns in the sub-user behavior to be determined. As described, sequences of behaviors by the sub-user can be ranked for determining a score which is used for determining whether a sub-user action has occurred.

Further, for an embodiment, different businesses physically visited can be rated, wherein particular businesses yield a higher success score and other particular businesses yield a lower success score. The success score of each business can be adaptively adjusted based on marketing messages and can be adjusted based on other businesses visited by the sub-user. For an embodiment, patterns of location visits by the sub-user can be used to influence the level of success. That is, for example, visiting a location of a business can be rated higher or lower based on a previous business visited by the sub-user.

As previously described, the sub-user tracking can include monitoring of web browsing of the sub-user. Online action and activity of the sub-user can influence the success score. Links accessed by the sub-user can be tracked. Websites visited by the sub-user can be tracked. Online purchases of the sub-user can be tracked. Each of the online web browsing of the sub-user can influence the success score of the sub-user actions.

For an embodiment, eye tracking of a sub-user can be sensed and used to see how long a sub-user observes an electronic message (how engaging the message is), or, how long the sub-user has the electronic message open on their screen. These observed actions can further be used to rank the success of generated electronic messages sent to sub-user(s).

For an embodiment, relationships between different sub-users are determined. For example, web tracking can determine online relationships between sub-users. Further, for an embodiment, a real physical relationship between sub-users can be established by tracking the locations of the different sub-users. Two sub-users may be identified as friends or associates or living together based on location tracking. Further, commonalities of recipients can be determined by identifying common locations, or common types of locations between the different sub-users. The influence one sub-user has on another sub-user can be measured and the influence can add or subtract from the success score.

For an embodiment, a level of sub-user action can be adaptively adjusted for each sub-user based on actions of an associated sub-user. An action by a related or common type of sub-user can influence how much an action by a sub-user influences the engagement determination or influences a success determination.

As previously described, the success determination of the described sub-user actions can be scored, and a score exceeding a score threshold can qualify as a sub-user action which is tracked.

The sub-user may then act upon the receiving and displaying of the electronic message(s). For an embodiment, the sub-user actions based on the displayed electronic message are monitored. For an embodiment, the sub-user actions are stored in the action database. For an embodiment, a second discriminator model of the server 101 generates a quality rating for each of the displayed electronic messages based on the previously described different sub-user actions. For an embodiment, the quality rating of each of the electronic messages is feedback to the server 101 to additionally influence the generation of electronic messages.

### Tracking User Actions

For an embodiment, the server 101 is configured to display the one or more electronic messages to the user. This allows the user to review and provide feedback if the user chooses to approve, update, or modify the one or more electronic messages.

For an embodiment, the server 101 is configured to display the sequential flow of electronic messages. This allows the user to review and provide feedback if the user chooses to approve, update, or modify the sequential flow of electronic messages.

For an embodiment, the server 101 is configured to sense actions by the user including, for example, sensing the user selecting, rejecting, or editing the one or more electronic messages, or the sequential flow of electronic messages. The actions and additional or alternate actions of the user can be tracked and monitored. The tracked and monitored actions can be used to train future generations of electronic messages and/or future generations of sequential flows of electronic messages. For an embodiment, the server 101 is further configured to feed the sensed actions back to the generator that generates the one or more electronic messages. For an embodiment, the feedback sensed actions are used to train the generator with the sensed action for future electronic messages.

For an embodiment, the user can review sequence(s) of electronic messages and/or the electronic messages before the electronic messages are electronically sent to the sub-users. During this review, the user can edit or modify the electronic messages before being sent to the sub-users. Further, the user can edit or modify the conditions of the sequential flow of electronic messages. These actions during the review of the sequential flows of electronic messages and electronic messages can be used to adaptively adjust future sequential flows of electronic messages and electronic messages based on monitoring the actions of the user. For an embodiment, the server 101 additionally tracks user actions based on the electronic messages displayed to the user of the user server 140. For at least some embodiments, the tracking of the user actions includes tracking the user selecting a displayed electronic message of a plurality of displayed electronic messages. Clicking the displayed electronic message indicates an interest by the user in the selected electronic message and indicates a level of value of the selected electronic message. For an embodiment, tracking of the user includes tracking the user modifying the electronic message, and submitting a final revised electronic message. For an embodiment, tracking of the user includes identifying differences between the electronic messages displayed to the user and the electronic message(s) sent by the user to sub-users of the user. Modifying a selected electronic message provides a level of value of the modified and submitted electronic message. For an embodiment, tracking of the user includes tracking future user copy (user copy is content written to promote or sell a product or service or to persuade readers to take a certain action. Marketing (user) copy is a useful tool that educates sub-users, provides resources and details contact information to help businesses increase awareness of their products and services) to identify if any of the electronic messages were used as tonal or stylistic inspiration in future communications. For an embodiment, tracking of the user actions includes tracking the user interacting with the electronic message generation system to allow more creative copy from users regardless of whether specific verbatim phrases are used in future communications. For an embodiment, tracking the actions of the user includes tracking messages sent by the user in any channel supported by the system including, for example, email, SMS, send push notifications, and others.

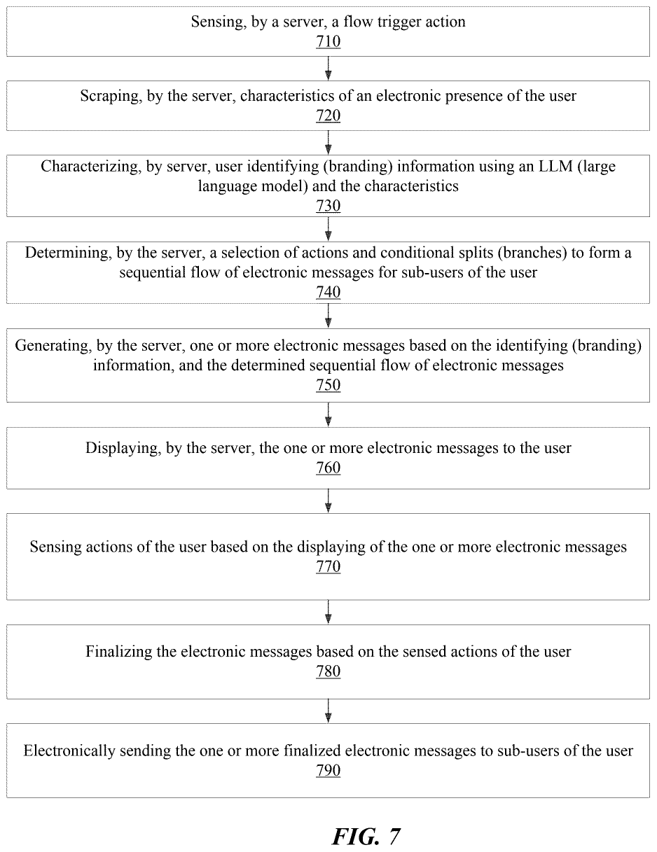

FIG. 7 is a flow chart that includes steps of a method for generating sequential flows of electronic messages, according to an embodiment. A first step 710 includes sensing, by a server, a flow trigger action. A second step 720 includes scraping, by the server, characteristics of an electronic presence of the user. A third step 730 includes characterizing, by server, user identifying (branding) information using an LLM (large language model) and the characteristics. A fourth step 740 includes determining, by the server, a selection of actions and conditional splits (branches) to form a sequential flow of electronic messages for sub-users of the user. A fifth step 750 includes generating, by the server, one or more electronic messages based on the identifying information, and the determined sequential flow of electronic messages. A sixth step 760 includes displaying, by the server, the one or more electronic messages to the user. A seventh step 770 includes sensing actions of the user based on the displaying of the one or more electronic messages. An eighth step 780 includes finalizing the electronic messages based on the sensed actions of the user. A ninth step 790 includes electronically sending the one or more finalized electronic messages to sub-users of the user.

As previously described, for an embodiment, sensing the flow trigger action comprises sensing an activity of the user indicating a need for generating the sequential flow of electronic messages for the user.

As previously described, for an embodiment, scraping characteristics of the electronic presence of the user comprises one or more of scraping characteristics of a user website, scaping characteristics of other electronic messages of the user, scaping code of a current message of the user.

As previously described, for an embodiment, characterizing the user identifying information using the LLM and the characteristics includes entering the characteristics including a spoken language of a website, a language of the website, colors of the website, images of the website, button selections of the website, and receiving the characterized user identifying information.

As previously described, for an embodiment, determining the selection of actions and conditional splits to form the sequential flow of electronic messages for sub-users of the user, includes receiving one or more selections of a plurality of pre-generated sequential flows of electronic messages from the user.

As previously described, for an embodiment, determining the selection of actions and conditional splits to form the sequential flow of electronic messages for sub-users of the user, comprises receiving one or more selections of a plurality of sequential flows of electronic messages of similar users from the user.

As previously described, for an embodiment, determining the selection of actions and conditional splits to form the sequential flow of electronic messages for sub-users of the user, comprises receiving one or more selections of a plurality of sequential flows of electronic messages adaptively generated from the user.

As previously described, for an embodiment, generating the one or more electronic messages based on the identifying information, and the determined sequential flow of electronic messages includes generating the one or more electronic messages, by a text generation engine, based on the identifying information, and the determined sequential flow of electronic messages.

As previously described, for an embodiment, displaying the one or more electronic messages to the user and sensing actions of the user based on the displaying of the one or more electronic messages includes receiving from the user one or more of and acceptance, an approval, a non-acceptance, editing of the one or more messages.

As previously described, at least some embodiments further include sensing action of the sub-users in response to receiving the one or more electronic messages. As previously described, at least some embodiments further include monitoring and tracking, by the server, responses of the sub-users to receiving the electronic messages, determining, by the server, a level of success of each of different of the electronic messages, and updating the generating of the electronic messages based on the determined level of success of each of different of the electronic messages. As previously described, for at least some embodiments updating the generating of the electronic messages includes feeding back the level of success of each of the different electronic messages to a generator that generated the different electronic messages.

As previously described, at least some embodiments further include sensing action of the sub-users in response to receiving the sequential flow of electronic messages, and feeding back the level of success of each of the sequential flow of electronic messages to a generator that generated the sequential flow of electronic messages. As previously described, at least some embodiments further include monitoring and tracking, by the server, responses of the sub-users to receiving the sequential flow of electronic messages, determining, by the server, a level of success of each of different of sequential flows of electronic messages, and updating the generating of the sequential flows of electronic messages based on the determined level of success of each of different of the sequential flows of electronic messages. For at least some embodiments, updating the generating of the sequential flow of electronic messages includes feeding back the level of success of each of different sequential flows of electronic messages to a generator that generated the sequential flows of electronic messages.

As previously described, at least some embodiments further include generating, by the server, two or more versions of the sequential flows of electronic messages, electronically sending the two or more versions of the sequential flows of electronic messages to sub-users, monitoring actions of the sub-users in response to receiving the two or more versions of the sequential flows of electronic messages, and ranking the two or more versions of the sequential flows of electronic messages based on the monitored actions. As previously described, at least some embodiments further include training a generator that generated the sequential flows of electronic messages based on the ranking of the two or more versions of the sequential flows of electronic messages.

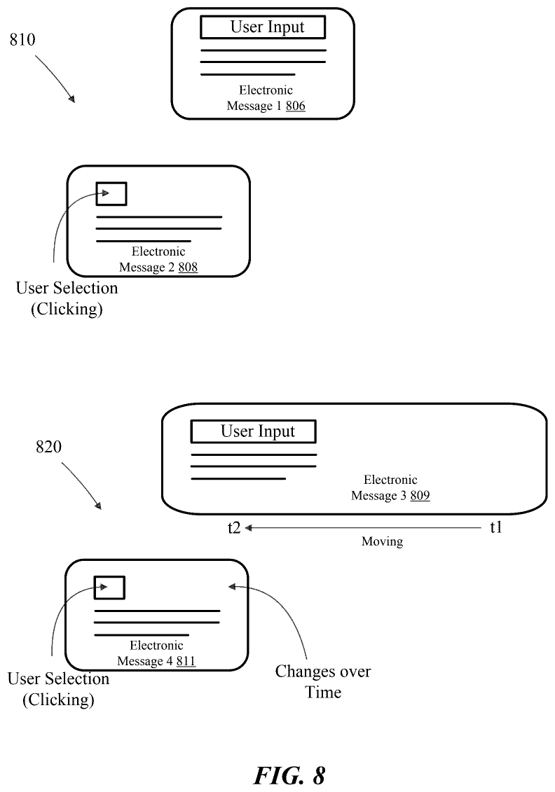

FIG. 8 shows electronic messages of a sequential flow of electronic messages, wherein each electronic message includes different content or behavior, according to an embodiment. For an embodiment, a display 810 of an electronic message 806 includes an input from a recipient (sub-user (site visitor), and an electronic message 808 that provides a user input through, for example, a selection, such as, through a mouse click. A display 820 includes an electronic message 809 that for an embodiment changes positions on the display between times t1 and t2, and an electronic message 811 that “pops up” a time t3 after the electronic message 811 has been loaded. Clearly, other electronic messages having different content and behavior can be utilized. As shown, for an embodiment, the different electronic messages operate to control a display of the electronic messages on a display of a computing device (such as, computing devices 104, 106) of sub-users (such as, recipients) 108, 112). As stated, for an embodiment, the different electronic messages provide the electronic communications of the A/B testing.

For an embodiment, the electronic message includes a file configured to receive an input from a recipient of the electronic message. For an embodiment, the required input includes at least one or more of the recipients clicking to a different page, or the recipient entering information. For an embodiment, the electronic message is distinct from an underlying website which may include a dynamic and interactive page. For an embodiment, the electronic messages are distinct from the underlying website because the electronic messages appear visually and/or behaviorally distinct from the underlying page. For example, the behavior of the electronic message may include the electronic message popping up after the page is loaded or sliding out from the side after the rest of the page has been loaded. As previously described, the different templates of an A/B test (or other comparative test) control the behavior of the electronic message, and accordingly, control the display of a recipient of the electronic message.

### Templates of Electronic Messages

For an embodiment, A/B testing includes N variations (arms) of templates that define electronic messages. For an embodiment, each of N templates includes a set of data objects that combine to represent a structure of an electronic message. As described, the first and second templates of the N templates of the electronic message each have a different content, a different send time, and/or a different behavior. The different displays of the mobile message can include a changing display, such as, movement or varying display intensity. Accordingly, the set of data objects of each of the first and second templates combine to represent a structure of electronic messages having a different content, different send times, or different behavior of the mobile messages. For an embodiment, the structure of the electronic message includes the content, the send time, or the behavior control. For an embodiment, the templates additional include information pertaining to testing of mobile message(s). The additional information can include, for example, a test name, a description of the test (makes it easier to remember what is being tested), an ending date, and/or specific settings that correspond to statistical significance criteria. For an embodiment, the additional information pertaining to the testing combined with the data for the templates define a test.

For an embodiment, the messages 806, 808, 809, 811 may be electronic messages. For an embodiment, the electronic messages require an input. A first display of a computing device of an electronic message recipient includes an electronic message 806 that requires an input from a user (electronic message recipient) and an electronic message 808 that requires a user input through, for example, a selection, such as, through a click. A second display includes an electronic message 809 that changes on the display between times t1 and t2, and an electronic message 811 that is delivered a time t3 after the electronic message has been sent. Clearly, other electronic messages having different content, send times, and behavior can be utilized. For an embodiment, templates that have different send times are sent to the electronic message recipients at different times. For an embodiment, a different send time of the first template and the second template include a first send time for the first template and a second send time of the second template. For an embodiment, messages received at different times during the day may be more or less likely to achieve success, based on trends observed in both electronic messages and email. That is, electronic message recipient behavior can be observed by prior electronic messages to the electronic message recipient, or other types of electronic mail sent to the electronic message recipient. Based on the observer (sensed) prior behavior of the electronic message recipient, the first and second send times can be selected. Further, there can be legal restrictions on send times, which influence the times the server selects for the first and second send times.

For an embodiment, the electronic message includes a file configured to receive an input from an electronic message recipient. For an embodiment, the required input includes at least one or more of the customers (site visitor) clicking to a different page, or the customer entering information. However, as previously mentioned, sensors of mobile devices of the electronic message recipients can be utilized to determine or detect actions of the electronic message recipients that indicate changes in behavior of the electronic message recipient due to receiving the electronic messages of the different templates.

An embodiment includes counting the successes of the electronic message sent to electronic message recipients of, for example, a group 1 and a group 2 according to a template 1 and a template 2. As previously described, for an embodiment, successes of the electronic messages generally include determining how many of the electronic message recipients of the electronic messages are sensed and tracked or determined to have performed a task of the electronic message. For an embodiment, the tracked and monitored activities of the electronic message recipients are online activities. For an embodiment, mobile devices of the electronic message recipients are tracked, and the tracked and monitored activities include locations and motions of the electronic message recipients.

For an embodiment, the electronic message recipients are obtained by tracking information of electronic message recipients to the user website managed by the user of the user server 140. For an embodiment, the electronic message recipients include recent electronic message recipients. For an embodiment, recent electronic message recipients include electronic message recipients that have visited the user website within a predetermined time-period. For an embodiment, electronic message recipients include a selected number of most recent user website visitors. For an embodiment, recent site visitors include electronic message recipients since a specific event. For an embodiment, the specific event may include, for example, a large change in the settings of a template test. For an embodiment, the assignment is random with equal probabilistic distributions within each geographical region that the test is sent to. For example, the electronic message may be sent to electronic message recipients from N different geographical regions. For an embodiment, an equal number (or near equal) of electronic messages is sent to each of the geographical regions, but randomly sent to the electronic message recipients within each of the regions. For an embodiment, the assignment is deterministic but equally distributed within each of the geographical regions. For example, a first template 1 can be assigned to a first member of the list of planned electronic message recipients, a second template 2 can be assigned to a second member of the list of planned electronic message recipients, and the first template can be assigned to a third member of the list of planned electronic message recipients, and so on.

For at least some embodiments, an eligibility of the electronic message recipient is determined dynamically by a combination of a geolocation of the electronic message recipient, transactional (for example, purchase confirmation, delivery confirmation) vs. marketing purpose of the electronic message, and recency of the last electronic message received. For example, only electronic message recipients who have not received a marketing email and/or marketing electronic message within the past 24 hours (or some other predetermined or adaptive time period X) are eligible to receive this message. For an embodiment, the planned electronic message recipients are determined when an electronic message is scheduled for transmission to the electronic message recipients. For an embodiment, when the electronic message is sent, the time that each planned electronic message recipient received their most recent marketing electronic message is determined, and only those electronic message recipients that have not received an electronic message in the past X hours are deemed eligible electronic message recipients.

For an embodiment, content in the template(s) is dynamically updated based on actions or characteristics of the sub-user (recipient). For example, different images or content of electronic messages of the templates are sent to the electronic message recipients based on the last product that an electronic message recipient browsed. Further, the mobile devices of the electronic message recipients can be tracked and monitored. For an embodiment, the content of the templates is additionally updated by physical location and activities of the electronic message recipients. The physical location and the activities can be sensed and/or identified based on locations and motion sensed by sensors of the mobile devices of the electronic message recipients.

For an embodiment, at least one of the plurality of mobile devices includes a location sensor and one or more motion sensors, and wherein the at least one of the plurality of mobile devices tracks locations and motions of a user of the at least one of the plurality of mobile devices, and the locations and motions of the user are included in the collected test data from the testing including the electronic message recipient actions of the first template of the electronic message and the second template of the electronic message.

As previously described, the described embodiments solve practical problems associated with automatically generating by a server or computing apparatus electronic messages and/or sequential flows of electronic messages that are likely to solicit a response from recipients (sub-users) of the electronic messages. Further, the described embodiments further solve practical problems associated with automatically identifying messages and characteristics (including a behavior) of messages that are more or less likely to solicit the response from the recipients (sub-users). Further, the described embodiments further solve practical problems associated with tuning the generation and other characteristics of the electronic messages based on preferences and actions of users who input a description for the electronic messages and based on tracking and monitoring the actions of recipients (sub-users) of the electronic messages. The different electronic messages may include different content and/or behavior. For an embodiment, the behavior can include the behavior of the display of the different electronic messages being different. For example, the display of different electronic messages may include motion of the display of the electronic messages. Accordingly, based on the sensed behavior of recipients of the electronic messages, the display may selectively vary. As shown in FIG. 8, the different behaviors of the electronic messages can include different motion and/or placement of features within a display of the electronic messages. For example, a selectable button within the display of the electronic messages can be located on the displays of the electronic messages based on the tracked actions and responses of the sub-users upon receiving the electronic messages. Locations and motions of the features of the displayed electronic messages can be adjusted based on the evaluated success of electronic messages having different locations and motion. Clearly other features, such as, text size, text location, text motion, fonts, colors, can additionally or alternatively be selected.

At least some embodiments include segmenting sub-user to receive the one or mor electronic messages. Further, different of the electronic messages can be segmented to different user. For an embodiment, segmentation may be used as a condition of the sequential flow of the electronic messages.

At least some embodiments further include generating two or more versions of identified sub-users of two or more segmentation versions, electronically sending electronic messages to the two or more versions of identified sub-users, monitoring actions of the two or more versions of identified sub-users based on responses to receiving the electronic messages, and ranking the two or more versions of the segmentation based on the monitored actions. At least some embodiments further include training future segmentations based on the rankings of the two or more versions of the segmentation.

### Selecting Sub-Users to Receive Generated Electronic Messages

As described, at least some embodiments include selecting which sub-users are to receive the generated electronic messages. For an embodiment, the sub-users are selected based on the type of computing device associated with the sub-user. Further, as described, for an embodiment, sub-users are adaptively selected to receive the generated electronic messages based on monitoring, sensing, or tracking of response of recipients (sub-users) of the electronic messages. That is, some recipients (sub-users) are more likely to perform an action based on receiving the generated electronic messages. For an embodiment, the sensing of the actions of the recipients is used to adaptively select which of the generated electronic messages to electronically send to each recipient. An embodiment includes adaptively selecting a list of sub-users for receiving the generated electronic messages based on sensed action of sub-users that receive the generated electronic messages. Past actions of each of the sub-users can be used to adapt the list of sub-users to receive future generated electronic messages.

For an embodiment fine tuning the generated electronic messages includes adaptively adjusting the recipients of the generated electronic messages based on the sensing the actions of the recipients of the generated electronic messages. That is, different recipients can be selected for different of the generated electronic messages. For each of the generated electronic messages a list of sub-user recipients for each can be adaptively adjusted based on the sensed actions of the recipient sub-users. For an embodiment, fine tuning the generated electronic messages includes adaptively adjusting a distribution of generated electronic messages amongst the sub-users.

### Selecting a Timing of Electronically Sending the Generated Electronic Messages

As described, at least some embodiments include selecting a send time of one or more of the generated electronic messages. For an embodiment, multiple of the generated electronic messages can be electronically sent to sub-users simultaneously. For example, a set of sub-users may be determined to be likely to respond to a particular type of electronic message. For an embodiment, the electronic messages may be sent to different sub-users at different times. For example, the sensing of action of recipients (sub-users) of the electronic messages can be used to adaptively adjust the timing of the sending of future electronic messages. For example, some sub-users may be adaptively determined to have performed an action based on receiving the electronic message versus some other sub-users. Accordingly, the timing of the electronic messages being sent may be adaptively adjusted based on the sensing of the actions of the recipient (sub-users) of the electronic messages. For an embodiment, a first electronic message may be sent at a first time, and a second electronic message may be sent at a later time. For an embodiment, the first time and the second time are selected by the user, and as described, are different times. For an embodiment, the first time and the second time are randomly selected and tested against each other to determine which is more effective at influencing a recipient to act upon receiving the electronic message. The sequence of the timing of the sending of the first electronic messages and the second electronic messages may be used to determine which of the first electronic messages or the second electronic messages are more effective for each sub-user.

### Tuning the Generation of the Electronic Messages

As described, at least some embodiments include sensing sub-user action based on receiving the generated electronic messages. The sensing may include sensing of any action performed by the recipient (sub-user) based on receiving the generated electronic messages.

At least some embodiments further include adjusting, by the server, the set of generated electronic messages including tuning the generated electronic messages based on sensing actions of the recipients of the generated electronic messages. For an embodiment, different versions of the generated electronic messages are sent to different sub-user recipients. Based on the sensed actions of the sub-user recipients, certain versions are favored over other versions. That is, the versions that caused an action to be performed by the recipient sub-user can be categorized as more effective in causing action by the recipient. The different versions of the generated electronic messages can be determined by the text of the generated electronic messages based on the text.

Over time, the actions of the recipients are learned, and what variation of the different types of electronic messages work the best is learned. For an embodiment, this can further include tuning to identify the importance of the text of the messages, how to condense the text, and how to draft the generated electronic messages.

As previously described, at least some embodiments include selecting a send time of one or more of the generated electronic messages. For an embodiment, multiple of the generated electronic messages can be electronically sent to sub-users simultaneously. For example, a set of sub-users may be determined to be likely to respond to a particular type of electronic message. For an embodiment, the electronic messages may be sent to different sub-users at different times. For example, the sensing of action of recipients (sub-users) of the electronic messages can be used to adaptively adjust the timing of the sending of future electronic messages. For example, some sub-users may be adaptively determined to have performed an action based on receiving the electronic message than some other sub-users. Accordingly, the timing of the electronic messages being sent may be adaptively adjusted based on the sensing of the actions of the recipient (sub-users) of the electronic messages. For an embodiment, a first electronic message may be sent at a first time, and a second electronic message may be sent at a later time.

As previously described, at least some embodiments include generating the one or more electronic messages based on the identifying information, and the determined sequential flow of electronic messages. However, other embodiments further include other inputs to the generator of the one or more electronic messages. As described, for at least some embodiments, an input description by the use can further be included in the generation of the one or more electronic messages. That is, the input description and a message generation request can be received from the user. As previously described, the electronic scraping can be used for determining the characteristics of the electronic presence of the user, which is then used for characterizing the user identifying (branding) information using an LLM (large language model) and the characteristics. Further, the scraped information can be used in the generation of the electron messages as well.

### Input Description

For an embodiment, the input description includes a text input. For an embodiment, the text input is limited to a set number of characters. However, for at least some other embodiments, the input description includes more than text. For embodiment, the input description includes an email. For example, for an embodiment, the input description includes images, such as, an image of a product. For an embodiment, input description includes an image of an email. For an embodiment, the input description further includes user preferences, such as, color schemes, brand voice, fonts, etc. For an embodiment, the input description can additionally include background images that the message section generator can generate and overlay text to be overlaid on top of the background images.

For an embodiment, the image can include figures, drawings, pictures, etc., but further includes at least some text embedded into the image. For an embodiment, the text of the image is not computer readable. For an embodiment, the server 101 further operates to extract and prioritize the at least text of the image of the input description. That is, the text of the image is extracted from the image. The extracted text is then prioritized based on, for example, the position or location of the text within the image. For an embodiment, the input description can include input data that has worked well in the past in generated electronic messages the solicit feedback from recipients (sub-users). For example, if it was determined that electronic messages in the past that included bright-colored buttons worked very well (high rate of responses from recipients, then the input description may be selected to include an instruction to use bright-colored buttons.

For an embodiment, the server operates to extract and prioritize the text of the image by converting the at least text of the image of the input description into machine-encoded text, and then prioritizing the text of the machine-encoded text based on at least a size and placement of the text of the image. For an embodiment, converting the image of the first channel electronic message includes applying optical character recognition (OCR) to the image. OCR is a technology that recognizes text within a digital image. OCR may be used to recognize text in scanned documents and images. OCR software can be used to convert a physical paper document, or an image into an accessible electronic version with text.

For an embodiment, an OCR algorithm is configured to determine coordinates of a box that includes the text.

### Scraping Characteristics

For an embodiment, scraping, by the server, characteristics of other electronic messages of the user comprises scraping code of a current message of the user, scraping code of other messages of the user, and/or scraping code of one or more websites of the user. For an embodiment, the scraping includes code that identifies characteristics of text and images of the messages of the user, and/or a website of the user.

For an embodiment, the scraping provides a determination of preferences of the user. For example, scraping may be used to determine the color preferences of the user. An embodiment includes determining the N (for example, 6) colors that are the most important to the user, and therefore, important to a brand of the user. For an embodiment, the determination is based on scraping code of a current message of the user. For an embodiment, the determination is based on scraping code of other messages of the user. For an embodiment, the determination is based on scraping code of one or more websites of the user. For an embodiment, the color determination is directed to text or wording of the user. An embodiment includes making the determination by counting letters of the messages or websites allocated to each color. An embodiment includes making the determination by counting words of the messages or websites allocated to each color. An embodiment includes determining the top X (such as, two) common background colors. For an embodiment, this includes scraping the code of the messages or websites of the user to determine the percentage of the background that is allocated to each color. An embodiment includes determining the top selectable button colors. For an embodiment, this includes scraping the code of the messages or websites of the user to determine the percentage of the selectable buttons that are allocated to each color. For an embodiment, this includes determining the number of words or the total number of words that are a color or font. For an embodiment, this includes determining the number of letters of the total number of letters that are of a color or font. For an embodiment, an electronic message rendering system of the server includes programming code operative to count the number of letters with each color. For an embodiment, the rendering system takes all the code and settings provided by the user and creates an electronic message/message section that is similar to what the recipient (sub-user) would see.

### Applying Colors, Fonts, and Other Formatting Options

For an embodiment, the server operates to apply colors, fonts, and other formatting options to the generated N message sections based on the scraped characteristics. The formatting options may include a selectable button width, button border styles, a button border width, padding, a font line spacing, and/or a font size. For an embodiment, the formatting options include any setting that can be applied to control the appearance of a piece of text or other element of the message.

### Receiving Feedback From the User

For an embodiment, the server operates to receive feedback from the user regarding the displayed filtered electronic message sections. The feedback may include a selection of one or more of the N message sections. Further, the feedback may include how the sub-user edits the message sections, written feedback, thumbs up and/or thumbs down-type rating which can be feedback to the text generation model. For an embodiment, the feedback may be user dependent. That is, different users may have different selection types. For an embodiment, the different selection types are feedback to the text generation model. That is, for an embodiment, the text generation by the text generation model is different for each user as defined by sensed or determined actions by each of the users.

For an embodiment, the server operates to electronically send the set of generated electronic messages to computing devices of sub-users. For an embodiment, the sub-users 108, 112 have visited a website of the user.

### Communicating Electronic Messages to Sub-Users (Recipients)

For an embodiment, the electronic messages are electronically sent to sub-users. For an embodiment, the sub-users have accessed a website of the user.

For an embodiment, the message generator generates one or more rough designs of the message sections and the server is configured to display the one or more rough designs. Subsequently, the server allows the user to give feedback and guide the message sections creation process, and/or allow the user to use the generator to iterate on designs of the message sections after the message sections are created, which could be fed back to the message section generator. For an embodiment, the message section generator includes at least one model, and the feedback from the user is used to update the one or more models. For an embodiment, over time, the server is configured to customize to each user based on what the user liked and didn't like (via feedback button, and/or via what the user did or did not choose to insert, or based on how the chose to edit one or more of the message sections. For an embodiment, the server is configured with the message section generator to customize generated content based on how users respond to prior content from that brand shown to the user by the model.

As described, for an embodiment, the server is configured to display the filtered and post-processed electronic message sections to the user. For an embodiment, up to M (for example, 3) of the remaining generations are then shown to the user via a carousel preview in the model. If the user likes one of the M options, then the user can select “Insert draft” and the selected section will be inserted into an electronic message of the user. Alternatively, the user can go back to the section description and attempt to update their description and regenerate M new options. Once completed, the electronic message is electronically sent to sub-users of the user.

For an embodiment, a separate, rules-based approach is applied to select, for example, the color palette, the header and body fonts, and the button-design applied to each of the generated sections. For an embodiment, the color palette is provided to the message section generator. The rule-based approach ensures that the eventual electronic message will have a sufficient color contrast to meet web accessibility guidelines and aesthetics.

As described, for an embodiment the message section generator includes an LLM (large language model) that receives a textual input. However, as described, the input description received from the user is not limited to text. The input description may include images as well. For an embodiment, the input description includes one or more images, and the message section generator includes a MMLLM (multi-model large language modal). For an embodiment, the user feedback and sensed sub-user actions are used for training the MMLLM.

As described, the feedback from the user can be used as the basis for one or more electronic messages that are sent to recipients (sub-users). That is, an embodiment includes generating electronic messages for sending to sub-users based on the filtered electronic message sections. The user may select a single message section as an electronic message, or the user may select multiple messages sections as a single electronic message.

At least some embodiments include electronically sending the electronic messages to sub-users of the users. At least some embodiments include monitoring and tracking, by the server, responses of the sub-users to receiving the electronic messages, determining, by the server, a level of success of each of different of the electronic messages, and updating the generating of the electronic messages and/or the sequences of the flow of electronic messages based on the determined level of success of each of different of the electronic messages. As described, for an embodiment, the sub-users have visited a website of the user. Further, for an embodiment, when the sub-user loads a webpage, user-tracking code is loaded in through a JavaScript bundle and utilized within the browser of the sub-user. For an embodiment, actions of the sub-user on the website of the user can be tracked. Further, a mobile device of a sub-user can be tracked to determine other possible actions of the sub-user. For an embodiment, forms that have been filled out and submitted to the website of the user can be monitored and tracked. For an embodiment, behavior of the sub-user's internet browser or device (that would affect communication of a message or a sub-user's desired action) can be monitored or tracked. For an embodiment, navigation by the sub-user to a website or URL (universal resource locator) can be sensed, tracked, and monitored.

Further, for an embodiment, different variations of the electronic messages can be tested against each other to allow a determination of what adjustments or parameter selections associated with the generation of the message sections and the electronic messages are more successful in soliciting a response from the recipient (sub-users). An embodiment further includes suggesting, by the server, two or more versions of the electronic messages, electronically sending the two or more versions of the electronic messages to sub-users, monitoring actions of the sub-users in response to receiving the two or more versions of the electronic messages and ranking the two or more versions of the electronic messages based on the monitored actions.

As previously described, the different variations may include different textual content, different color schemes, different layouts, different imagery, different send times, different lists of recipients, and/or different combinations of selected message sections. For an embodiment, the actions of the recipients (sub-users) of the different variations of the message sections and form electronic messages are tracked to determine which of the variations are more successful in soliciting responses of the recipients (sub-users). The success of the different responses can be ranked, and the ranking can be used to select the variations of future message sections and form electronic messages. That is, for an embodiment, the generator of the message section is trained based on the ranking of the two or more versions of the electronic messages. The ranking may influence the full management system that includes the message section generator.

Although specific embodiments have been described and illustrated, the embodiments are not to be limited to the specific forms or arrangements of parts so described and illustrated. The described embodiments are to only be limited by the claims.

What is claimed:

1. A method of generating a sequential flow of electronic actions for a user, comprising:
sensing, by a server, a flow trigger action;
scraping, by the server, characteristics of an electronic presence of the user;
characterizing, by server, user identifying information using an LLM (large language model) and the characteristics;
determining, by the server, a selection of actions and conditional splits to form a sequential flow of electronic messages for sub-users of the user;
generating, by the server, one or more electronic messages based on the identifying information, and the determined sequential flow of electronic messages;
displaying, by the server, the one or more electronic messages to the user;
sensing actions of the user based on the displaying of the one or more electronic messages;
finalizing the electronic messages based on the sensed actions of the user; and
electronically sending the one or more finalized electronic messages to sub-users of the user.

2. The method of claim 1, wherein sensing the flow trigger action comprises sensing an activity of the user indicating a need for generating the sequential flow of electronic messages for the user.

3. The method of claim 1, wherein scraping characteristics of the electronic presence of the user comprises one or more of scraping characteristics of a user website, scaping characteristics of other electronic messages of the user, scaping code of a current message of the user.

4. The method of claim 1, wherein characterizing the user identifying information using the LLM and the characteristics comprises:
entering the characteristics including a spoken language of a website, a language of the website, colors of the website, images of the website, button selections of the website; and
receiving the characterized user identifying information.

5. The method of claim 1, wherein determining the selection of actions and conditional splits to form the sequential flow of electronic messages for sub-users of the user, comprises receiving one or more selections of a plurality of pre-generated sequential flows of electronic messages from the user.

6. The method of claim 1, wherein determining the selection of actions and conditional splits to form the sequential flow of electronic messages for sub-users of the user, comprises receiving one or more selections of a plurality of sequential flows of electronic messages of similar users from the user.

7. The method of claim 1, wherein determining the selection of actions and conditional splits to form the sequential flow of electronic messages for sub-users of the user, comprises receiving one or more selections of a plurality of sequential flows of electronic messages adaptively generated from the user.

8. The method of claim 1, wherein generating the one or more electronic messages based on the identifying information, and the determined sequential flow of electronic messages comprises:
generating the one or more electronic messages, by a text generation engine, based on the identifying information, and the determined sequential flow of electronic messages.

9. The method of claim 1, wherein displaying the one or more electronic messages to the user and sensing actions of the user based on the displaying of the one or more electronic messages comprises receiving from the user one or more of and acceptance, an approval, a non-acceptance, editing of the one or more messages.

10. The method of claim 1, further comprising:
sensing action of the sub-users in response to receiving the one or more electronic messages.

11. The method of claim 10, further comprising:
monitoring and tracking, by the server, responses of the sub-users to receiving the electronic messages;
determining, by the server, a level of success of each of different of the electronic messages; and
updating the generating of the electronic messages based on the determined level of success of each of different of the electronic messages.

12. The method of claim 10, wherein updating the generating of the electronic messages comprises:
feeding back the level of success of each of the different electronic messages to a generator that generated the different electronic messages.

13. The method of claim 1, further comprising:
sensing action of the sub-users in response to receiving the sequential flow of electronic messages; and
feeding back the level of success of each of the sequential flow of electronic messages to a generator that generated the sequential flow of electronic messages.

14. The method of claim 13, further comprising:
monitoring and tracking, by the server, responses of the sub-users to receiving the sequential flow of electronic messages;
determining, by the server, a level of success of each of different of sequential flows of electronic messages; and
updating the generating of the sequential flows of electronic messages based on the determined level of success of each of different of the sequential flows of electronic messages.

15. The method of claim 13, wherein updating the generating of the sequential flow of electronic messages comprises:
feeding back the level of success of each of different sequential flows of electronic messages to a generator that generated the sequential flows of electronic messages.

16. The method of claim 13, further comprising:
generating, by the server, two or more versions of the sequential flows of electronic messages;
electronically sending the two or more versions of the sequential flows of electronic messages to sub-users;
monitoring actions of the sub-users in response to receiving the two or more versions of the sequential flows of electronic messages; and
ranking the two or more versions of the sequential flows of electronic messages based on the monitored actions.

17. The method of claim 16, further comprising training a generator that generated the sequential flows of electronic messages based on the ranking of the two or more versions of the sequential flows of electronic messages.

18. An apparatus, comprising:
a flow server;
a user server connected through a network to the flow server;
a plurality of sub-user computing devices connected through the network to the user server and the flow server;
wherein the flow server is configured to:
sense a flow trigger action;
scrape characteristics of an electronic presence of the user;
characterize user identifying information using an LLM (large language model) and the characteristics;
determine a selection of actions and conditional splits (branches) to form a sequential flow of electronic messages for sub-users of the user;
generate one or more electronic messages based on the identifying (branding) information, and the determined sequential flow of electronic messages;
display the one or more electronic messages to the user;
sense actions of the user based on the displaying of the one or more electronic messages;
finalize the electronic messages based on the sensed actions of the user; and
electronically send the one or more finalized electronic messages to sub-users of the user.

19. The apparatus of claim 18, wherein the flow server is further configured to:
generate two or more versions of the sequential flows of electronic messages;
electronically send the two or more versions of the sequential flows of electronic messages to sub-users;
monitor actions of computing devices of the sub-users in response to receiving the two or more versions of the sequential flows of electronic messages; and
rank the two or more versions of the sequential flows of electronic messages based on the monitored actions.

20. The method of claim 19, wherein the flow server is further configured to train a generator that generated the sequential flows of electronic messages based on the ranking of the two or more versions of the sequential flows of electronic messages.
